(19) United States
(12) Patent Application Publication
(10) Pub. No.: US 2020/0271993 A1
(43) Pub. Date: Aug. 27, 2020

(54) DISPLAY DEVICE AND DISPLAY DEVICE DRIVING METHOD

(71) Applicant: SAMSUNG DISPLAY CO., LTD., Yongin-si (KR)

(72) Inventors: Nam Jae LIM, Yongin-si (KR); Hoi Sik MOON, Yongin-si (KR); Yoon Gu KIM, Yongin-si (KR); Jae Sung BAE, Yongin-si (KR); Seung Young CHOI, Yongin-si (KR); Tae Hyeong AN, Yongin-si (KR)

(21) Appl. No.: 16/689,304

(22) Filed: Nov. 20, 2019

(30) Foreign Application Priority Data
Feb. 21, 2019 (KR) 10-2019-0020732

(51) Int. Cl. G02F 1/1335; G02F 1/1343

(52) U.S. Cl. CPC G02F 1/133602; G02F 1/134309; G02F 1/133615; G02F 2202/108; G02F 2001/133614; G02F 2001/134345; G02F 2203/30

(57) ABSTRACT

A display device having a backlight which includes a first quantity of light source blocks that are individually driven at separate duty ratios. The display device includes pixels having a second quantity that is greater than the first quantity. The pixels are configured to determine a light transmission factor for light emitted from the light source blocks. A grayscale compensation unit is configured to calculate color shift amounts of the pixels based on the duty ratios of the light source blocks and compensate input grayscale values for the pixels based on the color shift amounts to correct color shift.

### CROSS-REFERENCE TO RELATED APPLICATION

This application claims priority under 35 U.S.C. § 119 to Korean Patent Application No. 10-2019-0020732, filed on Feb. 21, 2019 in the Korean Intellectual Property Office, the disclosure of which is incorporated by reference in its entirety herein.

### TECHNICAL FIELD

The present invention relates to a display device and a display device driving method.

### DISCUSSION OF RELATED ART

Display devices have become increasingly important along with information technology advances since the display device serves as a connection medium between the user and the provided information. Display devices, such as a liquid crystal display device, an organic light emitting display device, or a plasma display device are increasingly used.

In particular, a display device which uses a blue LED as a light source and includes a backlight configured to cover the light source with a quantum dot sheet has been developed. This backlight has an advantage of providing a wide color gamut because the backlight may generate a narrow spectrum of a primary color as compared with other known backlights.

Backlight driving methods include a global dimming method in which the same duty ratio is applied to all light sources and a local dimming method in which a separate duty ratio is applied to each of the light sources.

When the local dimming method is used, there is an advantage of maximizing a luminance difference between a dark part and a bright part of an image, (e.g., a contrast ratio).

However, when the local dimming method is applied to a backlight that includes a quantum dot sheet, there is a problem that a color shift phenomenon occurs in which a dark part is yellow and a bright part is blue.

In order to solve the problem, a method may include the provision of a compensation film in the display device. However, display devices that include a compensation film are very expensive.

### SUMMARY OF THE INVENTION

Exemplary embodiments of the present inventive concepts provide a display device that prevents a color shift phenomenon from occurring when a local dimming method is applied to a backlight including a quantum dot sheet, without requiring a separate compensation film, and a display device driving method.

A display device according to one exemplary embodiment of the present inventive concepts includes a backlight which includes a first quantity of light source blocks that are individually driven at separate duty ratios. The display device includes pixels having a second quantity that is greater than the first quantity. The pixels are configured to determine a light transmission factor for light emitted from the light source blocks. A grayscale compensation unit is configured to calculate color shift amounts of the pixels on a basis of the duty ratios of the light source blocks and compensate input grayscale values for the pixels based on the color shift amounts to correct color shift.

The backlight may include light sources and a quantum dot sheet covering the light sources, and each of the light source blocks may be a region including at least one of the light sources.

The grayscale compensation unit may include a profile storage unit including color shift profiles for the light source blocks, and each of the color shift profiles may be a set of luminance values for each color for at least a part of the light source blocks when a corresponding light source block is in a light emission state and the remaining light source blocks are in a light non-emission state.

The grayscale compensation unit may further include a profile overlapping unit which generates a block unit profile by summing the color shift profiles to which weighted values are applied on the basis of the duty ratio information.

The grayscale compensation unit may further include an interpolation calculation unit which generates a pixel unit profile by interpolating luminance values for each color of the block unit profile.

The grayscale compensation unit may further include a compensation value calculation unit which generates a first compensation profile corresponding to a difference value between a target profile and the pixel unit profile.

The grayscale compensation unit may further include a gamma application unit which generates gamma grayscale values by reflecting a gamma curve on the input grayscale values.

The grayscale compensation unit may further include a compensation grayscale calculation unit which generates compensation grayscale values by applying the first compensation profile to the gamma grayscale values.

The grayscale compensation unit may further include an inverse gamma application unit which generates output grayscale values by reflecting an inverse gamma curve on the compensation grayscale values.

The grayscale compensation unit may further include a compensation ratio application unit which generates a second compensation profile by increasing a compensation value of the first compensation profile corresponding to a light source block having a lower luminance than an adjacent light source block on the basis of the duty ratio information.

Compensation values corresponding to the adjacent light source block in the first compensation profile and the second compensation profile may be equal to each other.

A display device driving method according to another exemplary embodiment of the present inventive concepts includes receiving duty information of light source blocks for an image frame. Color shift amounts of pixels are calculated on a basis of the duty ratio information. Input grayscale values of the pixels are received for the image frame. Input grayscale values are compensated based on the color shift amounts to correct color shift.

The compensating may further include generating a block unit profile by summing color shift profiles to which weighted values are applied on the basis of the duty ratio information, each of the color shift profiles may correspond to each of the light source blocks, and each of the color shift profiles may be a set of luminance values for each color for at least a part of the light source blocks when a corresponding light source block is in a light emission state and the remaining light source blocks are in a light non-emission state.

The compensating may further include generating a pixel unit profile by interpolating luminance values for each color of the block unit profile.

The compensating may further include generating a first compensation profile corresponding to a difference value between a target profile and the pixel unit profile.

The compensating may further include generating gamma grayscale values by reflecting a gamma curve on the input grayscale values.

The compensating may further include generating compensation grayscale values by applying the first compensation profile to the gamma grayscale values.

The compensating may further include generating output grayscale values by reflecting an inverse gamma curve on the compensation grayscale values.

The compensating may further include generating a second compensation profile by increasing a compensation value of the first compensation profile corresponding to a light source block having a lower luminance than an adjacent light source block on the basis of the duty ratio information.

Compensation values corresponding to the adjacent light source block in the first compensation profile and the second compensation profile may be equal to each other.

In another exemplary embodiment, a grayscale compensation unit includes a profile storage unit configured to store color shift profiles for light source blocks. A profile overlapping unit is configured to generate a block unit profile for each color by summing the color shift profiles and applying weighted values based on duty ratio information for the light source blocks. An interpolation calculation unit is configured to generate a pixel unit profile by interpolating luminance values for each color of the block unit profile. A compensation calculation unit is configured to generate a first compensation profile based on a difference value between a target profile and the pixel unit profile. The grayscale compensation unit is configured to generate output grayscale values that correct color shift based on the first compensation profile.

A display device and a display device driving method according to the present invention may prevent a color shift phenomenon from occurring when a local dimming method is applied to a backlight including a quantum dot sheet, without requiring a separate compensation film.

### BRIEF DESCRIPTION OF THE DRAWINGS

FIG. 1 is a diagram illustrating a display device according to an exemplary embodiment of the present inventive concepts.

FIG. 2 is a diagram illustrating a display panel according to an exemplary embodiment of the present inventive concepts.

FIG. 3 is a diagram illustrating a pixel according to an exemplary embodiment of the present inventive concepts.

FIG. 4 is a diagram illustrating a grayscale compensation unit according to an exemplary embodiment of the present inventive concepts.

FIGS. 5 to 8 are diagrams illustrating color shift profiles according to an exemplary embodiment of the present inventive concepts.

FIG. 9 is a diagram illustrating a process performed by the profile overlapping unit according to an exemplary embodiment of the present inventive concepts.

FIG. 10 is a diagram illustrating a process performed by the interpolation calculation unit according to an exemplary embodiment of the present inventive concepts.

FIG. 11 is a diagram illustrating a process performed by the gamma application unit according to an exemplary embodiment of the present inventive concepts.

FIG. 12 is a diagram illustrating a process performed by the inverse gamma application unit according to an exemplary embodiment of the present inventive concepts.

FIGS. 13 to 16 are diagrams illustrating a compensation ratio application unit according to an exemplary embodiment of the present inventive concepts.

### DETAILED DESCRIPTION OF THE EXEMPLARY EMBODIMENTS

Hereinafter, various exemplary embodiments of the present inventive concepts will be described in detail with reference to the accompanying drawings such that those skilled in the art may easily perform the present invention. The present inventive concepts may be embodied in many different forms and are not limited to the exemplary embodiments described herein.

In order to clearly illustrate the present inventive concepts, parts not related to the description are omitted, and the same or similar components are denoted by the same reference numerals or symbols throughout the specification. Therefore, the previously denoted reference numerals may be used in other drawings.

In addition, a size and a thickness of each configuration element illustrated in the drawings are randomly illustrated for the sake of convenient description, and the present invention is not limited to those illustrated in the drawings. In the drawings, the thickness may be exaggerated for clearly illustrating various layers and regions.

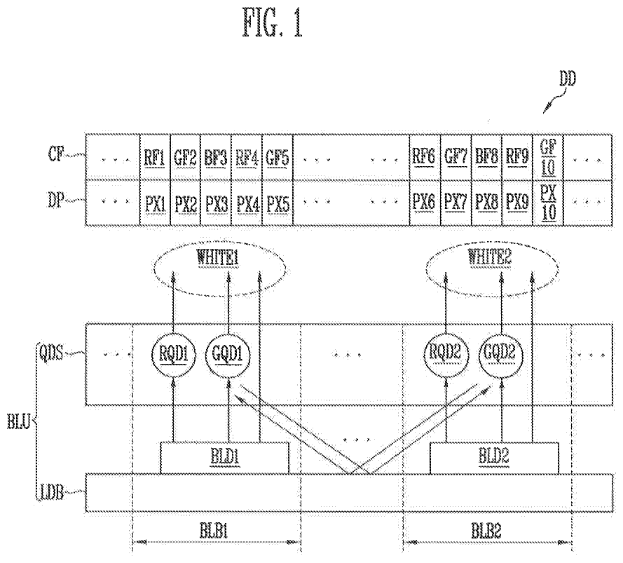

FIG. 1 is a diagram illustrating a display device according to an exemplary embodiment of the present inventive concepts.

Referring to FIG. 1, a display device DD according to an exemplary embodiment of the present inventive concepts may include a backlight BLU, a display panel DP, and a color filter CF. Color filter CF may be integrally configured with the display panel DP or may be configured separately from the display panel DP. Although not illustrated, a polarization plate or a polarization film may be further provided on at least one surface of the display panel DP.

The backlight BLU may include a plurality of light source blocks. In the exemplary embodiment shown in FIG. 1, light source blocks BLB1 and BLB2 are provided for convenience of description. However, exemplary embodiments are not limited thereto. Each of the light source blocks are individually driven at separate duty ratios. The separate duty ratios may be the same or different for each light source block. For example, the backlight BLU may include light sources BLD1 and BLD2 and a quantum dot sheet (QDS) covering the light sources BLD1 and BLD2. Each of the light source blocks BLB1 and BLB2 may be a region that includes at least one of the light sources BLD1 and BLD2.

The light source block having a high duty ratio may emit light with a relatively high luminance, and the light source block having a low duty ratio may emit light with a relatively low luminance. For example, the duty ratio may mean a ratio of an ON level to an OFF level of a pulse width modulation signal (PWM signal). The light source may be in a light non-emission state at the OFF level, and the light source may be in a light emission state at the ON level. The duty ratio increases as the ON level time increases. The light emission luminance of the light source increases as the duty ratio increases.

The light sources BLD1 and BLD2 may be located on a light source board LDB. The light source board LDB may be an electric circuit such as a printed circuit board (PCB), or a flexible PCB (FPCB). In another exemplary embodiment, the light source board LDB may be a mount for supporting the light sources BLD1 and BLD2 or may be a heat dissipation plate for cooling the light sources BLD1 and BLD2.

The light sources BLD1 and BLD2 may emit light of a first color if power is applied. In an exemplary embodiment, the first color may be blue. For example, the light sources BLD1 and BLD2 may be blue light emitting diodes (BLEDs) that emit blue light when power is applied.

The quantum dot sheet QDS may include second color quantum dots RQD1 and RQD2 that emit light of a second color and third color quantum dots GQD1 and GQD2 that emit light of a third color, when light is applied thereto. For example, in an exemplary embodiment, the second color may be red and the third color may be green. The quantum dot may be configured with a core, a shell, and ligands and have a configuration known in the art.

In other exemplary embodiments, the first color, the second color, and the third color may not be blue, red, and green, respectively. For example, the first color, the second color, and the third color may be red, blue, and green, respectively. In another exemplary embodiment, the first color, the second color, and the third color may be green, blue, and red, respectively. The color that the quantum dot emits may be set by changing the bandgap based on the size of the core and the wavelength. In the exemplary embodiments described herein, the first color is blue, the second color is red, and the third color is green for the sake of convenient description.

For example, if blue light is emitted from the light source BLD1, light not incident on the quantum dots RQD1 and GQD1 may be transmitted through the quantum dot sheet QDS and maintain a blue color. On the other hand, the light emitted from the light source BLD1 and incident on the second color quantum dot RQD1 may be converted into green light. In addition, light emitted from the light source BLD1 and incident on the third color quantum dot GQD1 may be converted into red light. Accordingly, since the blue light, the red light, and the green light are emitted in the light source block BLB1, a white light WHITE1 obtained by combining the blue light, the red light, and the green light may be emitted. In a similar manner, a white light WHITE2 may be emitted from the light source block BLB2.

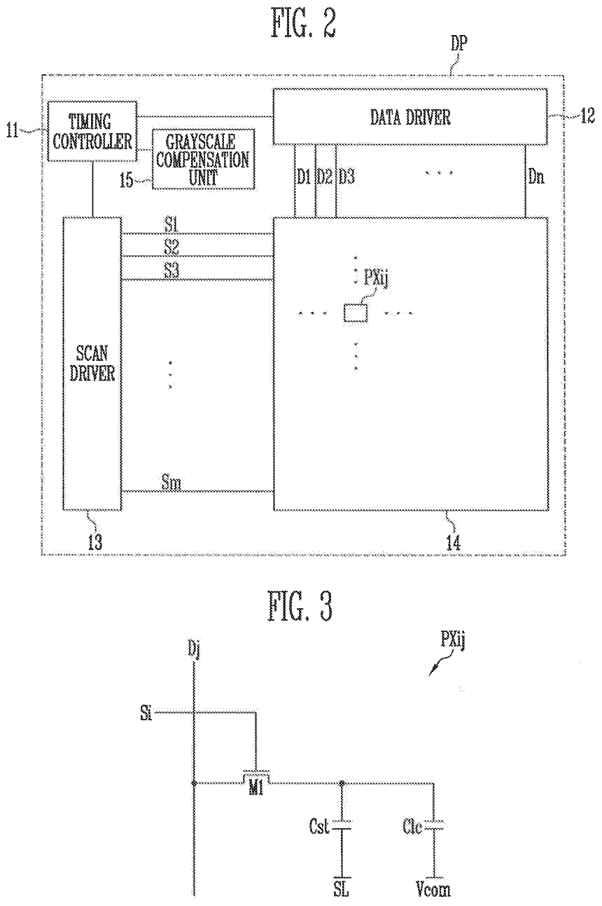

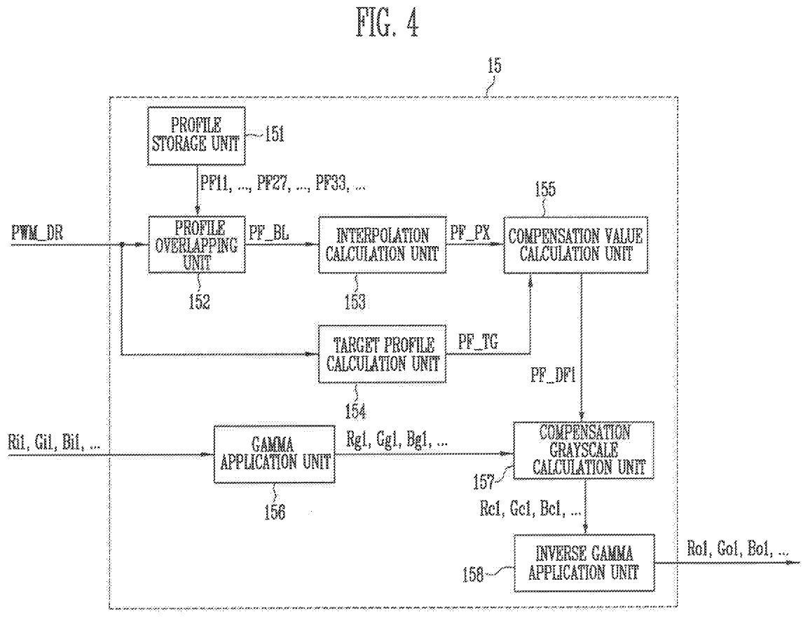

The display panel DP may include a plurality of pixels PX1, PX2, PX3, PX4, PX5, PX6, PX7, PX8, PX9, and PX10. The pixels PX1 to PX10 may determine a transmission factor, such as a grayscale of the light supplied from the light source blocks BLB1 and BLB2. The display panel DP and the pixels PX1 to PX10 will be described in more detail with reference to FIGS. 2 and 3.

The color filter CF may include color filter units RF1, GF2, BF3, RF4, GF5, RF6, GF7, BF8, RF9, and GF10 corresponding to the respective pixels PX1 to PX10. For example, the color filter units RF1, RF4, RF6, and RF9 may be red color filter units, the color filter units GF2, GF5, GF7, and GF10 may be green color filter units, and the color filter units BF3 and BF8 may be blue color filter units. Each of the color filter units RF1 to GF10 may determine a color of light that have a transmission factor determined by the pixels PX1 to PX10. According to the exemplary embodiment, the color filter CF may be located on an upper side of the display panel DP. In another exemplary embodiment, the color filter CF may be located under the display panel DP.

As described above, a final image frame determined by the duty ratio of the light source blocks BLB1 and BLB2, the transmission factor of the pixels PX1 to PX10, and the color of the color filter CF may be displayed to a user. If a plurality of image frames are continuously displayed, the display device may display a moving image to the viewer.

The white light WHITE1 may be influenced by the light emitted from not only the light source block BLD1 but also the light source block BLD2. Likewise, the white light WHITE2 may be influenced by the light emitted from not only the light source block BLD2 but also the light source block BLD1.

For example, when the duty ratios of the light source blocks BLD1 and BLD2 are equal to each other, the white lights WHITE1 and WHITE2 may be emitted regardless of whether the duty ratio is large or small.

However, when the duty ratio of the light source block BLD1 is larger than the duty ratio of the light source block BLD2, that is, when the light emission luminance of the light source block BLD1 is larger than the light emission luminance of the light source block BLD2, a specific gravity of the blue light emitted from the light source BLD1 among the white light WHITE1 of the light source block BLB1 may increase, and a specific gravity of the blue light emitted from the light source BLD2 among the white light WHITE2 of the light source block BLB2 may decrease. Consequently, the light source block BLB1 may emit the white light WHITE1 having a blue color and the light source block BLB2 may emit the white light WHITE2 having a yellow color.

This phenomenon is referred to as a color shift phenomenon.

FIG. 2 is a diagram illustrating the display panel according to an exemplary embodiment of the present inventive concepts.

Referring to FIG. 2, the display panel DP according to an exemplary embodiment of the present inventive concepts may include a timing controller 11, a data driver 12, a scan driver 13, a pixel unit 14, and a grayscale compensation unit 15.

The timing controller 11 may receive control signals and input grayscale values for an image frame from an external processor.

The grayscale compensation unit 15 may calculate color shift amounts of the pixels based on the duty ratio information for the light source blocks. The grayscale compensation unit may compensate the input grayscale values for the pixels 14 on the basis of the color shift amounts. For example, the grayscale compensation unit 15 may generate output grayscale values by compensating the input grayscale values for the pixels to correct for the color shift amounts.

The timing controller 11 may supply the data driver 12 with the output grayscale values and the control signals.

The data driver 12 may generate data signals to be provided to data lines D1, D2, D3, . . . , Dn using the output grayscale values, the control signals, and the like. For example, data signals generated for each pixel row ay be applied to the data lines D1 to Dn at the same time.

In addition, the timing controller 11 may generate a clock signal, a scan start signal, and the like and supply the signals to the scan driver 13 so as to conform to a specification of the scan driver 13.

The scan driver 13 may receive control signals such as the clock signal and the scan start signal from the timing controller 11 and generate scan signals to be supplied to scan lines S1, S2, S3, . . . , Sm. The scan driver 13 may select at least a part of the pixels to which the data signals are to be written by providing the scan signals through the scan lines S1 to Sm. For example, in an exemplary embodiment, the scan driver 13 may select the pixel rows to which the data signals are to be written by sequentially providing the scan signals of a turn-on level to the scan lines S1 to Sm. The scan driver 13 may be configured in a form of a shift register and may generate the scan signals in a manner so that the scan start signal is sequentially transferred to the next stage circuit under a control of the clock signal.

The pixel unit 14 includes a plurality of pixels PXij. Each of the pixels PXij may be connected to a corresponding data line and a corresponding scan line. For example, if the data signals for one pixel row are applied to the data lines D1 to Dn from the data driver 12, the data signals may be written to the pixel rows located on the scan lines that receive the scan signals of a turn-on level from the scan driver 13.

FIG. 3 is a diagram illustrating a pixel according to an exemplary embodiment of the present inventive concepts.

Referring to FIG. 3, the pixel PXij may include a transistor M1, a storage capacitor Cst, and a liquid crystal capacitor Clc.

In the present exemplary embodiment, the transistor M1 is illustrated as an N-type transistor, Accordingly, the turn-on level of the scan signal may be a high level. However, in alternative embodiments, the transistor M1 may be a P-type transistor and the pixel circuit may be modified accordingly.

The transistor M1 may have a gate electrode connected to the scan line Si, a first electrode connected to the data line Dj, and a second electrode connected to an electrode of the storage capacitor Cst and a pixel electrode of the liquid crystal capacitor Clc.

The storage capacitor Cst may have one electrode connected to the second electrode of the transistor M1, and the other electrode connected to a sustain voltage line SL. According to an exemplary embodiment, when capacitance of the liquid crystal capacitor Clc is sufficient, a configuration of the storage capacitor Cst may be excluded.

The liquid crystal capacitor Clc may have the pixel electrode connected to the second electrode of the transistor Ml, and a common electrode to which a common voltage Vcom is applied. A liquid crystal layer may be located between the pixel electrode and the common electrode of the liquid crystal capacitor Clc.

If the scan signal of a turn-on level is supplied to the gate electrode of the transistor M1 through the scan line Si, the transistor M1 connects the data line Dj to one electrode of the storage capacitor Cst. Accordingly, a voltage corresponding to a difference between the data signal applied through the data line Dj and a sustain voltage of the sustain voltage line SL is stored in the storage capacitor Cst. A voltage equal to the data signal is maintained at the pixel electrode of the liquid crystal capacitor Clc by the storage capacitor Cst. Accordingly, an electric field corresponding to the difference between the data signal and the common voltage may be applied to the liquid crystal layer, and orientations of liquid crystal molecules in the liquid crystal layer may be determined according to the electric field. Therefore, a transmission factor corresponding to the orientations of the liquid crystal molecules may be set according to the data signal and scan signal.

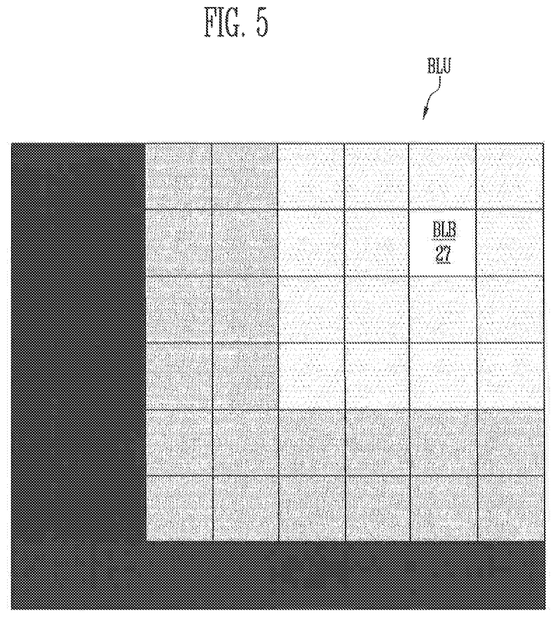

FIG. 4 is a diagram illustrating a grayscale compensation unit according to an exemplary embodiment of the present inventive concepts.

Referring to FIG. 4, a grayscale compensation unit 15 according to an exemplary embodiment of the present inventive concepts may include a profile storage unit 151, a profile overlapping unit 152, an interpolation calculation unit 153, a target profile calculation unit 154, a compensation value calculation unit 155, a gamma application unit 156, a compensation grayscale calculation unit 157, and an inverse gamma application unit 158. However, in some exemplary embodiments, some elements of the grayscale compensation unit 15 may be excluded to implement only a part of various functions of the grayscale compensation unit 15.

The grayscale compensation unit 15 may be integrally configured with the timing controller 11 or the data driver 12 or may be configured by independent hardware, such as an integrated circuit. In an exemplary embodiment, the grayscale compensation unit 15 may be configured as software within the timing controller 11 or the data driver 12. However, each of the elements 151 to 158 of the grayscale compensation unit 15 may be configured by individual hardware or may be configured by hardware obtained by combining some of the elements. The respective elements 151 to 158 of the grayscale compensation unit 15 may also be configured as a software product(s).

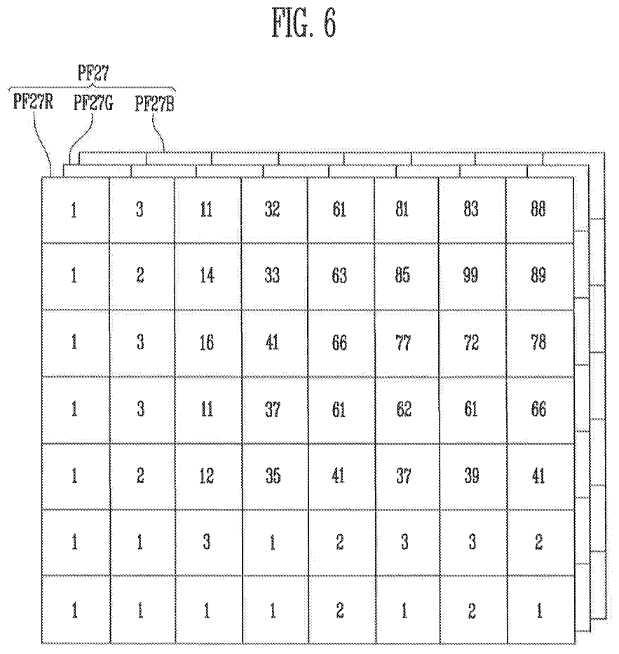

The profile storage unit 151 may store color shift profiles for the light source blocks. For example, in the exemplary embodiment shown in FIG. 4, the specific color shift profiles PF11, PF27, and PF33 are shown for convenience of description. In an exemplary embodiment, each of the color shift profiles PF11, PF27, and PF33 may be a set of luminance values for each color for at least a part of the light source blocks when the corresponding light source block is in a light emission state and the remaining light source blocks are in a light non-emission state. The color shift profiles PF11, PF27, and PF33 will be described below in more detail with reference to FIGS. 5 to 8.

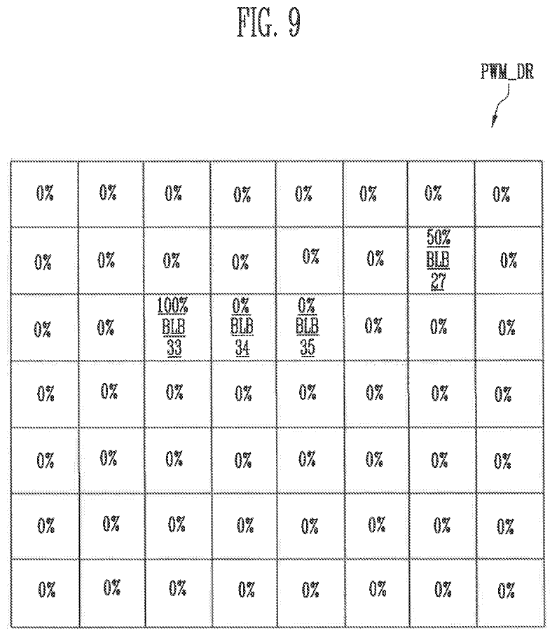

The profile overlapping unit 152 may perform a summing of the color shift profiles (e.g., PF11, PF27, and PF33) to which weighted values are applied on the basis of duty ratio information PWM_DR and generate a block unit profile PF_BL. The profile overlapping unit 152 will be described below in more detail with reference to FIG. 9.

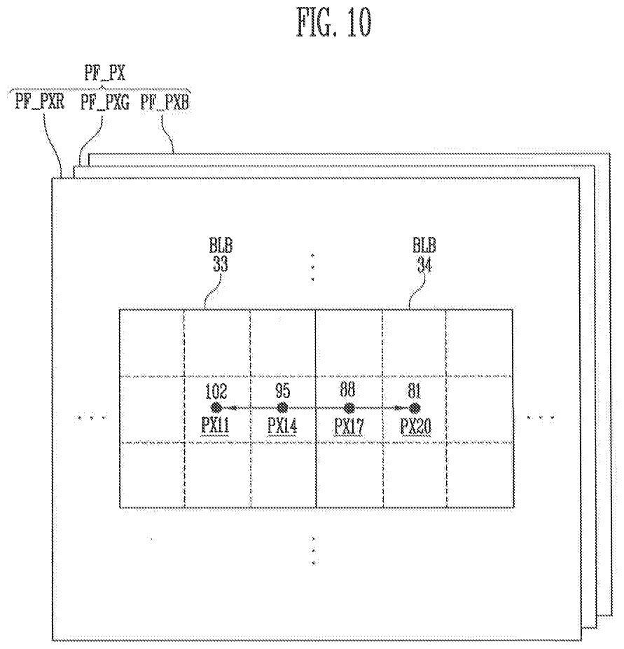

The interpolation calculation unit 153 may generate a pixel unit profile PF_PX by interpolating the luminance values for each color of the block unit profile PF_BL. The interpolation calculation unit 153 will be described below in more detail with reference to FIG. 10.

The target profile calculation unit 154 may generate a target profile PF_TG. The target profile PF_TG may be an ideal color profile emitted by the display device when there is no color shift phenomenon.

For example, the target profile calculation unit 154 may generate the target profile PF_TG on the basis of the duty ratio information PWM_DR. For example, it is possible to know the luminance of each light source block through the duty ratio information PWM_DR, and to calculate the target luminance value for each color for configuring a corresponding luminance. In an exemplary embodiment, the luminance of each light source block may be defined by Equation 1.

Y=aR+bG+cB [Equation 1]

Y is the luminance of the light source block, R is the red target luminance value, G is the green target luminance value, and B is the blue target luminance value. a, b, and c may be predetermined constants. For example, according to ITU-R is recommendation BT.601[1], a may be 0.299, b may be 0.587, and c may be 0.114.

The compensation value calculation unit 155 may generate a first compensation profile PF_DF1 corresponding to a difference value between the target profile PF_TG and the pixel unit profile PF_PX. The difference value may be referred to as a compensation value.

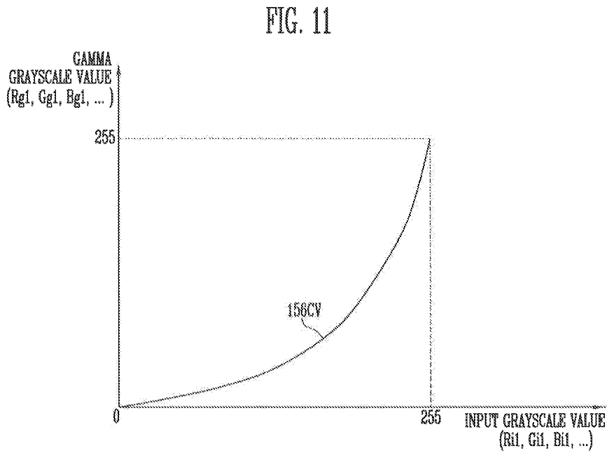

The gamma application unit 156 may generate gamma grayscale values Rg1, Gg1, and Bg1 by reflecting a gamma curve on the input grayscale values Ri1, Gi1, and Bi1. The gamma application unit 156 will be described below in more detail with reference to FIG. 11.

The compensation grayscale calculation unit 157 may generate compensation grayscale values Rc1, Gc1, and Bc1 by applying the first compensation profile PF_DF1 to the gamma grayscale values Rg1, Gg1, and Bg1. For example, the compensation grayscale calculation unit 157 may generate the compensation grayscale values Rc1, Gc1, and Bc1 by adding values of the first compensation profile PF_DF1 to the gamma grayscale values Rg1, Gg1, and Bg1.

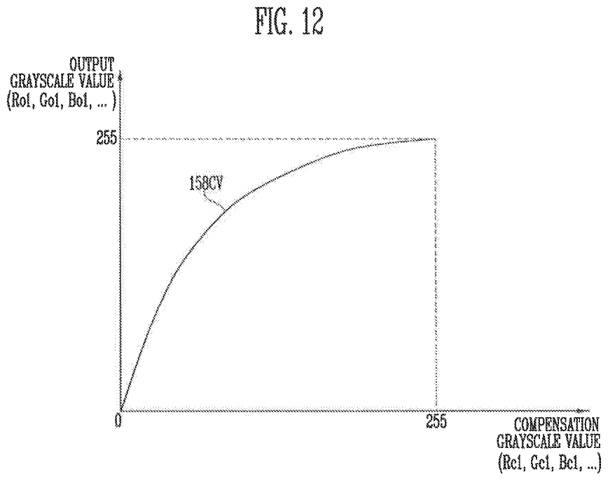

The inverse gamma application unit 158 may generate output grayscale values Ro1, Go1, and Bo1 by reflecting an inverse gamma curve on the compensation grayscale values Rc1, Gc1, and Bc1. The inverse gamma application unit 158 will be described below in more detail with reference to FIG. 12.

FIGS. 5 to 8 are diagrams illustrating the color shift profiles according to exemplary embodiments of the present inventive concepts.

The profile storage unit 151 may be configured to store the color shift profiles PF11, PF27, and PF33 for the light source blocks. Each of the color shift profiles PF11, PF27, and PF33 may be a set of luminance values for each color for at least a part of the light source blocks when the corresponding light source block is in a light emission state and the remaining light source blocks are in a light non-emission state.

Referring to FIG. 5, a case where a light source block BLB27 of the backlight BLU is in the light emission state and the remaining light source blocks are in the light non-emission state is illustrated in accordance with an exemplary embodiment.

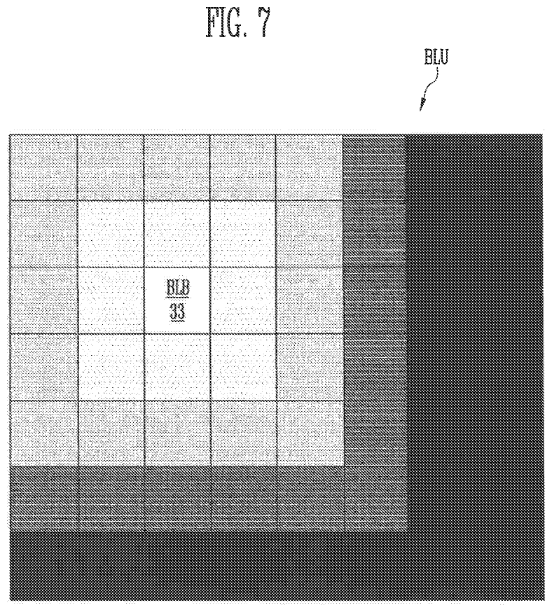

Referring to FIG. 6, an exemplary color shift profile PF27 for the light source blocks in the state of FIG. 5 is illustrated. The color shift profile PF27 may include a red shift profile PF27R, a green shift profile PF27G, and a blue shift profile PF27B. Each of the color-based shift profiles PF27R, PF27G, and PF27B may be a set of luminance values for each color for at least a part of the respective light source blocks.

When a display device DD in the state of FIG. 5 is imaged by an external camera, a color profile of an XYZ coordinate system may be obtained, and the color shift profile PF27 may be obtained by converting the color profile of the XYZ coordinate system into a color profile of an RGB coordinate system, The conversion from the XYZ coordinate system into the RGB coordinate system may be performed by a conversion method known in the art. The converted color profile may be stored in the profile storage unit 151 of the display device DD as the color shift profile PF27 before the product is shipped.

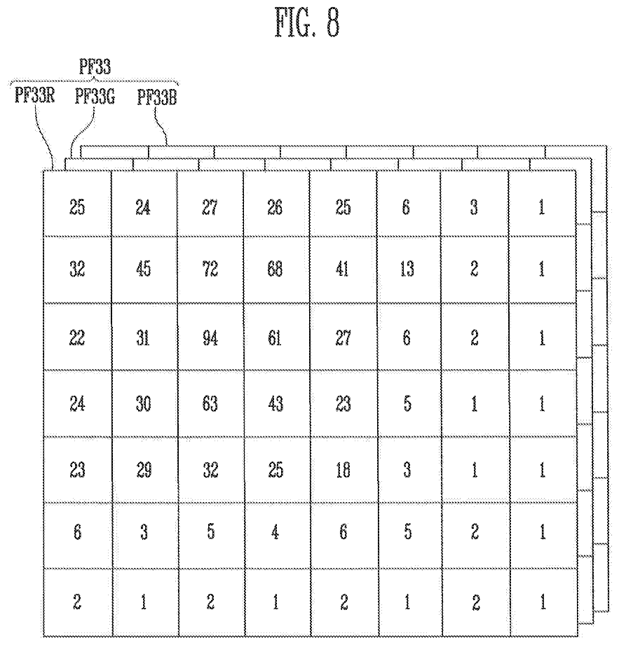

Referring to FIG. 7, a case where a light source block BLB33 of the backlight BLU is in the light emission state and the remaining light source blocks are in the light non-emission state is illustrated.

Referring to FIG. 8, an exemplary color shift profile PF33 in the state of FIG. 7 is illustrated. The color shift profile PF33 may include a red shift profile PF33R, a green shift profile PF33G, and a blue shift profile PF33B. A duplicate description thereon will be omitted.

In an exemplary embodiment, the luminance values for each color in FIGS. 6 and 8 may be normalized values for the input grayscale values Ri1 , Gi1, and Bi1. For example, if the input grayscale values Ri1, Gi1, and Bi1 are represented by 0 to 255 grayscales, the luminance values for each color may be normalized such that a minimum value is 0 and a maximum value is 255.

FIG. 9 is a diagram illustrating the profile overlapping unit according to the exemplary embodiment of the present invention.

The profile overlapping unit 152 may generate the block unit profile PF_BL by summing the color shift profiles (e.g., PF11, PF27, and PF33) to which weighted values are applied on the basis of the duty ratio information PWM_DR.

For example, in an exemplary embodiment, according to the duty ratio information PWM_DR, a duty ratio of the light source block BLB27 may be 50%, a duty ratio of the light source block BLB33 may be 100%, and the duty ratio of the remaining light source blocks BLB34, BLB35, . . . may be 0%.

According to an exemplary embodiment, as the duty ratio of the light source block increases, the weighted value of the corresponding light source block may be set to be high, and as the duty ratio of the light source block decreases, the weighted value of the corresponding light source block may be set to be low.

For example, in an exemplary embodiment, the weighted value of the light source block BLB27 having a 50% duty ratio may be set to 0.5, the weighted value of the light source block BLB33 having a 100% duty ratio may be set to 1, and the weighted values of the remaining light source blocks BLB34, BLB35, . . . may be set to 0.

In this embodiment, the block unit profile PF_BL may be generated by multiplying the color shift profile PF27 of FIG. 6 by 0.5, multiplying the color shift profile PF33 of FIG. 8 by 1, and by multiplying the color shift profiles of the remaining light source blocks BLB34, BLB35, . . . by 0, and by summing those for each color.

For example, in this exemplary embodiment a red luminance value corresponding to the light source block BLB27 in the block unit profile PF_BL may be 51.5 according to following Equation 2.

99*0.5+2*1=51.5 [Equation 2]

In addition, for example, the red luminance value corresponding to the light source block BLB33 in the block unit profile PF_BL may be 102 according to following Equation 3.

16*0.5+94*1=102 [Equation 3]

In addition, for example, the red luminance value corresponding to the light source block BLB34 in the block unit profile PF_BL may be 81.5 according to following Equation 4.

41*0.5+61*1=81.5 [Equation 4]

By repeating the processes, it is possible to generate a red block unit profile among the block unit profile PF_BL.

The processes may be repeated for the green and blue block unit profiles of the block unit profile PF_BL.

FIG. 10 is a diagram illustrating the interpolation calculation unit according to the exemplary embodiment of the present invention.

The interpolation calculation unit 153 may generate a pixel unit profile PF_PX by interpolating the luminance values for each block of the block unit profile PF_BL. The pixel unit profile PF_PX may include a red pixel unit profile PF_PXR, a green pixel unit profile PF_PXG, and a blue pixel unit profile PF_PXB.

The quantity of the light source blocks (e.g., BLB33, BLB34, etc.) may be smaller than the quantity of the pixels (e.g., PX11, PX14, PX17, PX20, etc.). For example, in FIG. 10, it is assumed that the respective light source blocks BLB33, BLB34 correspond to 27 pixels (red, blue, and green). For example, it is assumed that each of the light source blocks BLB33, BLB34, in the red pixel unit profile PF_PXR of the pixel unit profile PF_PX corresponds to nine pixels (red).

Correspondence between a light source block and a pixel may mean that a main light source of the corresponding pixel is the corresponding light source block in terms of a physical location relationship between the light source block and the pixel.

The luminance values for each block included in the block unit profile PF_BL may be a representative value for the corresponding light source block. For example, luminance value may be a luminance value for a pixel located at the center of the light source block.

For example, when the pixel PX11 is a red pixel and the pixel PX11 is located at the center of the light source block BLB33, the red shift luminance value of the pixel PX11 may be 102 obtained by Equation 3.

In addition, when the pixel PX20 is a red pixel and the pixel PX20 is located at the center of the light source block BLB34, the red shift luminance value of the pixel PX20 may be 81.5 obtained by Equation 4. However, in the exemplary embodiments shown in FIG. 10, the red shift luminance value of the pixel PX20 is denoted as 81 excluding a decimal point thereof for the sake of easy calculation.

The pixels PX14 and PX17 may be located between the pixels PX11 and PX20. In this embodiment, the interpolation calculation unit 153 may calculate the red shift luminance value by making 102 and 81 associate with the physical location relationship between the pixels PX11, PX14, PX17, and PX20 and interpolating the values between 102 and 81. For example, the red shift luminance value of the pixel PX14 may be 95 and the red shift luminance value of the pixel PX17 may be 88.

The processes may be repeated for the green and blue pixel unit profiles PF_PXG and PF_PXB.

FIG. 11 is a diagram illustrating the gamma application unit according to an exemplary embodiment of the present inventive concepts.

The gamma application unit 156 may generate the gamma grayscale values Rg1, Gg1, and Bg1 by reflecting a gamma curve on the input grayscale values Ri1, Gi1, and Bi1.

Since the input grayscale values Ri1, Gi1, and Bi1 may be provided by an external processor and do not include luminance information, a grayscale value conversion is required to calculate the first compensation profile PF_DF1 including the luminance information.

A gamma value of a gamma curve 156CV, for example, 2.0 gamma, 2.2 gamma, or 2.4 gamma may change depending on the display device DD.

FIG. 12 is a diagram illustrating the inverse gamma application unit according to the exemplary embodiment of the present invention.

The inverse gamma application unit 158 may generate output grayscale values Ro1, Co1, and Bo1 by reflecting an inverse gamma curve on the compensation grayscale values Rc1, Gc1, and Bc1.

Since the data driver 12 generates the data signals using the gamma voltages on which the gamma values are reflected, it is necessary to prevent the gamma value from being reflected twice. Accordingly, the inverse gamma application unit 158 may generate the output grayscale values Ro1, Ga1, and Bo1 by applying an inverse gamma curve 158CV to the compensation grayscale values Rc1, Gc1 and Bc1.

An inverse gamma value of the inverse gamma curve 158CV may be an inverted gamma value of the gamma curve 156CV of FIG. 11.

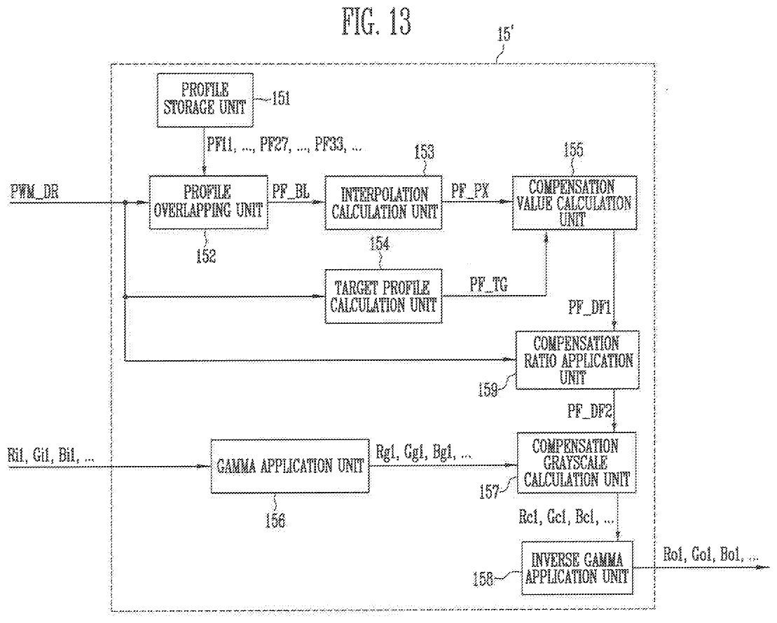

FIGS. 13 to 16 are diagrams illustrating a compensation ratio application unit according to the exemplary embodiment of the present invention.

Referring to FIG. 13, a grayscale compensation unit 15′ may further include a compensation ratio application unit 159.

The compensation ratio application unit 159 may generate a second compensation profile PF_DF2 by increasing a compensation value of the first compensation profile PF_DF1 corresponding to the light source block having a lower luminance than the adjacent light source block on the basis of the duty ratio information PWM_DR.

The compensation values corresponding to the adjacent light source blocks in the first compensation profile PF_DF1 and the second compensation profile PF_DF2 may be equal to each other.

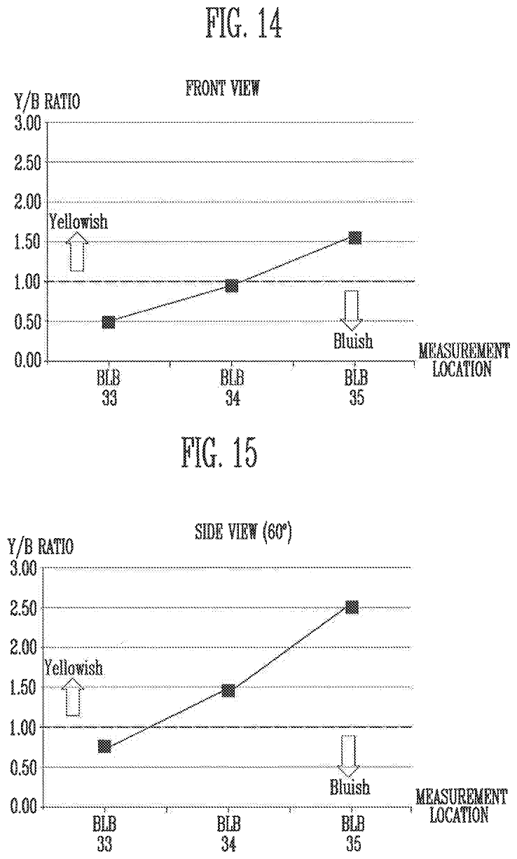

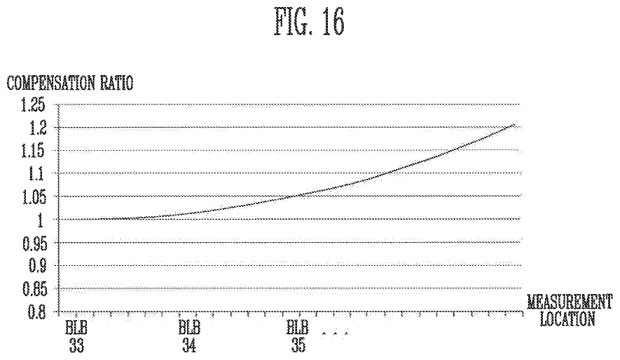

FIG. 14 is a graph obtained by measuring ratios of yellow to blue (“Y/B ratios”) of the light source blocks BLB33, BLB34, and BLB35 on a front view of the display device DD. FIG. 15 is a graph obtained by measuring Y/B ratios of the light source blocks BLB33, BLB34, and BLB35 on a side view inclined by 60 degrees from the front view of the display device DD. In the present exemplary embodiment, FIG. 9 may be referred to for the exemplary duty ratio information PWM_DR of the light source blocks BLB33, BLB34, and BLB35. As the Y/B ratio increases, yellow appears more, and as the Y/B ratio decreases, blue appears more.

As shown in the exemplary embodiments of FIGS. 14 and 15, the light source block BLB35 has a lower luminance than the adjacent light source block BLB33. The Y/B ratio is higher in light source block BLB 35 than for light source block BLB33 which has a higher luminance. In addition, as shown in FIG. 15, the Y/B ratio is higher in light blocks BLB33, BLB34 and BLB35 in the side view than in the front view.

Accordingly, it may be necessary to increase a compensation ratio for the light source block BLB35 having a relatively low luminance.

Referring to FIG. 16, for example, the compensation ratio application unit 159 may apply a compensation ratio of 1 to the light source block BLB33, apply a compensation ratio of 1.02 to the light source block BLB34, and apply a compensation ratio of 1.05 to the light source block BLB35 based on their relative luminances.

Accordingly, compensation values in the first compensation profile PF_DF1 and the second compensation profile PF_DF2 of the light source block BLB33 may be equal to each other. On the other hand, the light source blocks BLB34 and BLB35 may have larger compensation values in the second compensation profile PF_DF2 than the compensation value in the first compensation profile PF_DF1.

The detailed description on the drawings and the invention set forth above merely exemplifies the invention, is used for the purpose of describing the present invention only, and is not used to limit the meaning and the scope of the present invention described in the claims or the claims. It is therefore to be understood by those skilled in the art that various modifications and equivalent other exemplary embodiments may be implemented. Accordingly, the true technical protection scope of the present invention should be determined by the technical idea of the appended claims.

What is claimed is:

1. A display device comprising:
a backlight which includes a first quantity of light source blocks that are individually driven at separate duty ratios;
pixels having a second quantity that is greater than the first quantity, the pixels configured to determine a light transmission factor for light emitted from the light source blocks; and
a grayscale compensation unit that is configured to calculate color shift amounts of the pixels based on the duty ratios of the light source blocks and compensate input grayscale values for the pixels based on the color shift amounts to correct color shift.

2. The display device of claim 1,
wherein the backlight includes a plurality of light sources and a quantum dot sheet covering the plurality of light sources, and
wherein each of the light source blocks is a region including at east one of the plurality of light sources.

8. The display device of claim 1,
wherein the grayscale compensation unit includes a profile storage unit that is configured to store color shift profiles for the light source blocks, and
wherein each of the color shift profiles comprises a set of luminance values for each color for at least a part of the light source blocks when a corresponding light source block is in a light emission state and remaining light source blocks are in a light non-emission state.

4. The display device of claim 3, wherein the grayscale compensation unit further includes a profile overlapping unit which generates a block unit profile by summing the color shift profiles to which weighted values are applied on the basis of the duty ratio information.

5. The display device of claim 4, wherein the grayscale compensation unit further includes an interpolation calculation unit that is configured to generate a pixel unit profile by interpolating luminance values for each color of the block unit profile.

6. The display device of claim 5, wherein the grayscale compensation unit further includes a compensation value calculation unit that is configured to generate a first compensation profile corresponding to a difference value between a target profile and the pixel unit profile.

7. The display device of claim 6, wherein the grayscale compensation unit further includes a gamma application unit which is configured to generate gamma grayscale values by reflecting a gamma curve on the input grayscale values.

8. The display device of claim 7, wherein the grayscale compensation unit further includes a compensation grayscale calculation unit that is configured to generate compensation grayscale values by applying the first compensation profile to the gamma grayscale values.

9. The display device of claim 8, wherein the grayscale compensation unit further includes an inverse gamma application unit that is configured to generate output grayscale values by reflecting an inverse gamma curve on the compensation grayscale values.

10. The display device of claim 6, wherein the grayscale compensation unit further includes a compensation ratio application unit that is configured to generate a second compensation profile by increasing a compensation value of the first compensation profile corresponding to a light source block having a lower luminance than an adjacent light source block based on the duty ratios of the light source blocks.

11. The display device of claim 10, wherein compensation values corresponding to the adjacent light source block in the first compensation profile and the second compensation profile are equal to each other.

12. A display device driving method, comprising:
receiving duty ratio information of light source blocks for an image frame;
calculating color shift amounts of pixels on a basis of the duty ratio information;
receiving input grayscale values of the pixels for the image frame; and
compensating the input grayscale values on a basis of the color shift amounts to correct color shift.

13. The display device driving method of claim 12,
wherein the compensating further includes generating block unit profile by summing color shift profiles to which weighted values are applied on the basis of the duty ratio information,
wherein each of the color shift profiles corresponds to each of the light source blocks, and
wherein each of the color shift profiles is a set of luminance values for each color for at least a part of the light source blocks when a corresponding light source block is in a light emission state and remaining light source blocks are in a light non-emission state.

14. The display device driving method of claim 13, wherein the compensating further includes generating a pixel unit profile by interpolating luminance values for each color of the block unit profile.

15. The display device driving method of claim 14, wherein the compensating further includes generating a first compensation profile corresponding to a difference value between a target profile and the pixel unit profile.

16. The display device driving method of claim 15, wherein the compensating further includes generating gamma grayscale values by reflecting a gamma curve on the input grayscale values.

17. The display device driving method of claim 16, wherein the compensating further includes generating compensation grayscale values by applying the first compensation profile to the gamma grayscale values.

18. The display device driving method of claim 17, wherein the compensating further includes generating output grayscale values by reflecting an inverse gamma curve on the compensation grayscale values.

19. The display device driving method of claim 15, wherein the compensating further includes generating a second compensation profile by increasing a compensation value of the first compensation profile corresponding to a light source block having a lower luminance than an adjacent light source block based on the duty ratio information.

20. The display device driving method of claim 19, wherein compensation values corresponding to an adjacent light source block in the first compensation profile and the second compensation profile are equal to each other.
